(19) United States
(12) Patent Application Publication
(10) Pub. No.: US 2014/0127653 A1
(43) Pub. Date: May 8, 2014

(54) LANGUAGE-LEARNING SYSTEM

(71) Applicants: Moshe LINK, Haifa (IL); Shmuel WEISSBERGER, Haifa (IL); Joel WALTERS, Maalot (IL); Shalom LAMPERT, Maalot (IL); Danny NIR, Moreshet (IL)

(72) Inventors: Moshe LINK, Haifa (IL); Shmuel WEISSBERGER, Haifa (IL); Joel WALTERS, Maalot (IL); Shalom LAMPERT, Maalot (IL); Danny NIR, Moreshet (IL)

(21) Appl. No.: 14/153,035

(22) Filed: Jan. 12, 2014

Related U.S. Application Data
(63) Continuation of application No. PCT/US2012/045878, filed on Jul. 8, 2012.

(30) Foreign Application Priority Data
Jul. 11, 2011 (GB) 1111756.1

(51) Int. Cl. G09B 19/06

(52) U.S. Cl. CPC G09B 19/06
USPC 434/157

(57) ABSTRACT

A language learning system and method for facilitating learning of a foreign language by a human reader having relative fluency in a familiar language.

### CROSS-REFERENCE TO RELATED APPLICATIONS

This application is a continuation of PCT Application No. PCT/US2012/045878, which draws priority from UK Patent Application No. 1111756.1, filed Jul. 11, 2011, which applications are incorporated by reference for all purposes as if fully set forth herein.

### FIELD AND BACKGROUND OF THE INVENTION

The present invention relates to a computer-implemented method and system useful in the learning of a foreign language.

A simple and effective method for learning a foreign language is to read entertaining literature in that language. However, the need to constantly refer to a dictionary, even an electronic one, slows down the reading process, often making what should be an enjoyable experience into a tedious one, thus discouraging the reader.

A well-known solution to this problem involves printing the foreign language text and the familiar language translation thereof on opposing pages of a book, whereby quick reference to the translation may be achieved. In referring to the translation, however, relatively extensive eye movements (in conventional as well as non-conventional directions) are required. This may interrupt the reading of the foreign language text sufficiently to destroy the flow of the reading process. As a result of non-routine, back-and-forth eye movements, the reader may have to invest time and attention in locating and comprehending the word or group of words in the translated text that correspond to the word or group of words in the foreign language that require translation. Only subsequently can the reader return to the foreign language text, find the location of the usage in question, and then apply the corresponding translation within that context.

Alternatively, the familiar language translation may be printed adjacent to a foreign language text, whereby lines of the foreign and the familiar text are interleaved. U.S. Pat. No. 3,126,647 discloses this type of arrangement, in which the familiar text is printed in such small size type as to be unreadable to the normal unaided eye. When the familiar language translation of a word in the foreign text is required, a hand magnifying glass is brought into position over the translation, rendering it visible. Similarly, U.S. Pat. No. 4,891,011 discloses a system in which a familiar language translation is printed directly beneath the foreign language text using a medium which is generally invisible to the human eye unless exposed to light of a specified frequency range, such as ultraviolet light. The reader is provided with a portable light source of the specified frequency that may be used to illuminate the translation when required.

U.S. Pat. No. 6,438,515 discloses a method and apparatus for displaying dual texts in a manner to facilitate language learning. A highly visible “study text” is presented, the text divided into individual units of thought that are preferably formatted in association with less visible units of a “teach text”, provided in proximity, upon a separate focal plane, thus effecting a bitextual, bifocal presentation.

The improvements of the prior art notwithstanding, the present inventors have recognized a need for improved methods and systems for learning foreign languages.

### SUMMARY OF THE INVENTION

According to the teachings of the present invention there is provided a computer-implemented language learning system for facilitating learning of a foreign language by a human reader having relative fluency in a familiar language, the system including: (a) a processor; (b) a memory, associated with the processor, the memory adapted to store: (i) a first text in a first language, the text including a first plurality of words or phrases, the plurality having a length of least 50 words, and (ii) a pre-translated second text in a second language, the pre-translated second text including a human, contextual, translation of the first text, the second text including a second plurality of translated words or phrases, the second plurality having a length of least 50 words, the processor and the memory including an associating mechanism adapted to dispose each translated word or phrase of the translated words or phrases and a respective word or phrase of the words or phrases of the first text, within the memory, in a paired, associative structure; (c) a display medium, responsive to the processor, the medium adapted to simultaneously display: (i) a plurality of lines of the first text, wherein each line of at least two lines of the plurality of lines of the first text includes at least two phrases of the first plurality of the phrases, and (ii) a plurality of translated lines within the pre-translated second text, the translated lines including translated lines corresponding to the two lines of the first text, wherein each translated line of at least two translated lines of the plurality of translated lines includes at least two phrases of the second plurality of the phrases, wherein, the processor is adapted, after each translated word or phrase of the translated words or phrases and the respective word or phrase of the words or phrases of the first text are disposed within the memory in the uniquely associated or paired manner, (i) to receive a prompt pertaining to a first word or phrase on a particular line of the two lines of the first text, and responsive to the prompt, and (ii) to identify, using the paired structure, a particular translated word or phrase of the plurality of translated words or phrases in the pre-translated second text, the particular translated word or phrase being a human, contextual translation of the first word or phrase; and (iii) to control the display medium, to modify an appearance of the particular translated word or phrase, whereby a display of the particular translated word or phrase is imparted with a physical distinction with respect to at least a portion of a corresponding translated line within the at least two translated lines.

According to another aspect of the present invention there is provided a computer-implemented method for assisting a learning of a foreign language to a reader having fluency in a familiar language, the method including the steps of: (a) providing the system as described above or essentially as described herein; (b) prompting the system with the prompt pertaining to the first word or phrase of the first text; (c) identifying the particular translated word or phrase of the plurality of translated words or phrases, and (d) controlling the display medium, to modify the appearance of the particular translated word or phrase, whereby the display of the particular translated word or phrase is imparted with the physical distinction with respect to the corresponding translated line within the at least two translated lines.

According to still further features in the described preferred embodiments, a timing device is adapted to provide, to the processor, a series of prompts, including the prompt, each of the prompts pertaining to a different word or phrase of the first text, wherein the processor is adapted, responsive to each particular prompt of the prompts, to identify an associated translated word or phrase of the plurality of translated words or phrases that is associated with the particular prompt, and to control the display medium, to modify the appearance of the associated translated word or phrase, whereby a display of the associated translated word or phrase is imparted with a physical distinction with respect to other words on a same line within the second text.

According to still further features in the described preferred embodiments, the processor is further adapted to control the display medium, in response to the prompt, to modify an appearance of the first word or phrase of the first text, whereby a display of the first word or phrase is imparted with a physical distinction with respect to at least a portion of the particular line of the first text.

According to still further features in the described preferred embodiments, the appearance of the first word or phrase is substantially identical to the appearance of the particular translated word or phrase.

According to still further features in the described preferred embodiments, the processor and the display are adapted wherein the first text and the second text are interleaved.

According to still further features in the described preferred embodiments, the processor and the display are adapted wherein each line of the second text is juxtaposed above or below each line of the first text.

According to still further features in the described preferred embodiments, the processor and the display are adapted wherein each line of the second text is substantially a linear translation of each line of the first text.

According to still further features in the described preferred embodiments, the first word or phrase of the first text represents a key, and the particular translated word or phrase represents associated data associated with the key.

According to still further features in the described preferred embodiments, the first word or phrase of the first text represents a key, and the particular translated word or phrase represents associated data uniquely associated with the key.

According to still further features in the described preferred embodiments, the processor and the memory are adapted to store a plurality of pointers, wherein a particular pointer of the pointers is associated with the first word or phrase of the first text, and wherein the particular pointer points to a location of the particular translated word or phrase.

According to still further features in the described preferred embodiments, the processor and the memory are adapted to store the particular pointer in a known location with respect to the first word or phrase of the first text.

According to still further features in the described preferred embodiments, the processor and the memory are adapted to store a length of the particular translated word or phrase as data associated with the particular pointer.

According to still further features in the described preferred embodiments, the processor and the memory are adapted to store the particular translated word or phrase in an adjacent position or otherwise known relation with respect to the first word or phrase of the first text, thereby obviating a need for a pointer pointing to the particular translated word or phrase.

According to still further features in the described preferred embodiments, the processor and the memory are adapted to store the plurality of translated words or phrases in a list or table.

According to still further features in the described preferred embodiments, the system further includes an input device adapted to provide the prompt.

According to still further features in the described preferred embodiments, the input device includes a user-activated input device.

According to still further features in the described preferred embodiments, the input device includes a user-activated input device selected from the group consisting of a mouse, a touchpad, or a touchscreen, or any functional equivalents thereof.

According to still further features in the described preferred embodiments, the system is adapted, in assembled form, wherein at least a portion of at least one of the processor and the memory is disposed in a remote location, with respect to the display medium.

According to still further features in the described preferred embodiments, the system is adapted, in assembled form, wherein at least a portion of at least one of the processor and the memory is disposed on a remote side of the system, and the display medium is on a local side of the system.

According to still further features in the described preferred embodiments, the system is adapted, in assembled form, wherein at least one of the processor and the memory is disposed on a remote side of the system, and the display medium is on a local side of the system, the remote side and the local side adapted to communicate via a communication network.

According to still further features in the described preferred embodiments, the network includes an Internet.

According to still further features in the described preferred embodiments, the local side of the system includes an input/output (I/O) port adapted to transmit information to or from the remote side of the system.

According to still further features in the described preferred embodiments, the processor, the memory, and the display medium are adapted, in assembled form, to physically communicate within an integral system.

According to still further features in the described preferred embodiments, the processor is adapted to control the display medium, to modify the appearance of the particular translated word or phrase, whereby the physical distinction of the particular translated word or phrase is a distinction achieved by a feature selected from the group of features consisting of highlight, boldface, italics, font size, font color, underlining, and flashing.

According to still further features in the described preferred embodiments, the system is adapted to control the display medium, to remove the physical distinction after a pre-determined time, or responsive to reader input of the reader.

According to still further features in the described preferred embodiments, an input device is adapted to provide the reader input.

According to still further features in the described preferred embodiments, the reader input includes activation of the input device in a pre-determined fashion.

According to still further features in the described preferred embodiments, the timing device is adapted to provide, to the processor, a second prompt pertaining to a second word or phrase of the first text, wherein the processor is adapted, responsive to the second prompt, to identify a second particular translated word or phrase of the plurality of translated words or phrases, and to control the display medium, to modify an appearance of the second particular translated word or phrase, whereby a display of the second particular translated word or phrase is imparted with a physical distinction with respect to other words on a same line within the second text.

According to still further features in the described preferred embodiments, the timing device is adapted to provide the series of prompts at a substantially constant time interval.

According to still further features in the described preferred embodiments, the timing device is adapted to provide the series of prompts at a particular time interval, the interval being adjustable by a user of the system, via an input device adapted to define the time interval.

According to still further features in the described preferred embodiments, the system further includes a pace input device, associated with at least one of the timing device and the processor, the pace input device adapted to enable the user to set a particular pace for the series of prompts.

According to still further features in the described preferred embodiments, the system further includes a mode switch, associated with at least one of the timing device and the processor, the mode switch adapted to enable the user to select between a plurality of modes of operation, the modes including a variable pace mode providing the series of prompts at the particular time interval, and a user-activated input mode in which the user effects the prompts by means of a user-activated input device.

According to still further features in the described preferred embodiments, the user-activated input device is selected from the group of devices consisting of a mouse, a touchpad, or a touchscreen.

According to still further features in the described preferred embodiments, the system further includes an audio arrangement, responsive to the processor, and adapted to deliver the first text as audible text.

According to still further features in the described preferred embodiments, the system further includes an audio arrangement adapted to deliver the first text as audible text, and a mode switch, associated with at least one of the timing device and the processor, the mode switch adapted to enable the user to select between a plurality of modes of operation, the modes including a pace mode providing the series of prompts at the particular time interval, and an audio mode in which the audio arrangement effects a delivery of the first text as the audible text.

According to still further features in the described preferred embodiments, the processor is further adapted to control the display medium, in response to the prompt, to modify an appearance of the first word or phrase of the first text, whereby a display of the first word or phrase is imparted with a physical distinction with respect to at least a portion of the particular line of the first text, and wherein the display of the first word or phrase is imparted with the physical distinction substantially concurrently with, or in overlapping fashion to, the delivery of the first word or phrase of the first text as the audible text.

According to still further features in the described preferred embodiments, the length of the first plurality of words or phrases, exceeds 100 words, 150 words, 250 words, 500 words, or 1000 words.

According to still further features in the described preferred embodiments, the length of the second plurality exceeds 100 words, 150 words, 250 words, 500 words, or 1000 words.

According to still further features in the described preferred embodiments, at least two lines of the first text and at least two lines of the second text have at least 5 words.

According to still further features in the described preferred embodiments, an average line length of the first text is at least 5 words.

According to still further features in the described preferred embodiments, an average line length of the second text is at least 5 words.

According to still further features in the described preferred embodiments, the processor is adapted to store a record of user-initiated prompts.

According to still further features in the described preferred embodiments, the processor is adapted to evaluate a language acumen of the reader.

According to still further features in the described preferred embodiments, the processor is adapted to evaluate a language acumen of the reader, based on the user-initiated prompts.

According to still further features in the described preferred embodiments, the processor is adapted to store a record of user-initiated prompts, and to provide, via the display medium or other output medium, a review of words or phrases associated with the user-initiated prompts, whereby a language learning of the reader is reinforced.

According to still further features in the described preferred embodiments, the processor is adapted to store diagnostic information on a reading performance of the reader, the diagnostic information including a record of user-initiated prompts.

According to still further features in the described preferred embodiments, the processor is further adapted to evaluate, based on the diagnostic information, a foreign-language level of the reader.

According to still further features in the described preferred embodiments, the processor is further adapted to evaluate, based on the diagnostic information, weak points of the reader that require strengthening.

According to still further features in the described preferred embodiments, the processor is adapted to store a record of user-initiated prompts, and based on the record, to provide, via the display medium or other output medium, a test of a language learning of the reader.

According to still further features in the described preferred embodiments, the processor is further adapted to determine, based on the diagnostic information, a language-learning level of the reader.

According to still further features in the described preferred embodiments, the first text is a plurality of first texts, the second text is a plurality of translated second texts.

According to still further features in the described preferred embodiments, the first text is a plurality of first texts, the second text is a plurality of translated second texts, and the processor is further adapted to recommend, based on the diagnostic information pertaining to the user, a user-appropriate level of the first texts.

According to still further features in the described preferred embodiments, the processor is adapted to retrieve at least two levels of translation of at least a portion of the first text.

According to still further features in the described preferred embodiments, the processor is adapted to retrieve, from the memory, both an idiomatic translation and a more literal translation, of at least a portion of the first text.

According to still further features in the described preferred embodiments, the pre-translated second text constitutes a human, contextual, translation of the first text.

According to still further features in the described preferred embodiments, the pre-translated second text and the first text are pre-associated.

According to still further features in the described preferred embodiments, each translated word or phrase of the translated words or phrases and the respective word or phrase of the words or phrases of the first text, within the memory, are disposed in a paired, associative structure.

According to still further features in the described preferred embodiments, each translated word or phrase of the translated words or phrases and the respective word or phrase of the words or phrases of the first text, within the memory, are disposed in a uniquely paired, associative structure.

According to still further features in the described preferred embodiments, the method of the present invention further includes the step of: controlling the display medium, in response to the prompt, to modify an appearance of the first word or phrase of the first text, whereby a display of the first word or phrase is imparted with a physical distinction with respect to at least a portion of the particular line of the first text. According to still further features in the described preferred embodiments, the pre-translated second text and the first text are associated by a human associator.

According to still further features in the described preferred embodiments, the pre-translated second text and the first text are downloaded from a computer network.

According to still further features in the described preferred embodiments, the computer network includes an Internet network.

According to still further features in the described preferred embodiments, the pre-translated second text is pre-translated solely by a human translator.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a block diagram of a system according to the present invention;

FIG. 2 shows an exemplary display of an English text as the foreign language, and a Hebrew text as the familiar language;

FIG. 3 provides an illustrative embodiment of a pointer-based architecture associating a word or phrase from a second text with a word or phrase from a first text;

FIG. 4 provides an exemplary table that may contain each word or phrase from the first text, and each corresponding translated word or phrase from the second text in an adjacent position or in an otherwise known relation;

FIG. 5 provides a schematic illustration of a system such as a computer system, a portable or laptop computer, or an electronic book, according to one embodiment of the present invention; and

FIGS. 6A-6E illustrate an inventive mode of operation in which succeeding words of the first text are physically distinguished, along with the translated words of the second text.

### DESCRIPTION OF THE PREFERRED EMBODIMENTS

The principles and operation of the inventive computer-implemented methods and systems for learning foreign languages may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The instant invention pertains to a reading-based, computer-implemented method and system for learning a foreign language. While reading in one's familiar language may be exciting, entertaining, or otherwise stimulating, we have found that attempts to read in a foreign language, even for those having reasonable familiarity with that foreign language, may be frustrating or otherwise unenjoyable. The use of a dictionary (traditional, electronic, or web-based) or other language aids may temper or moderate the frustration, but may often fail to appreciably improve the situation. The periodic need to refer to the dictionary or to other language aids may make the reading experience cumbersome or tedious, discouraging the reader, and reducing both the learning efficacy and the length of the learning period.

Moreover, the various language aids available may often supply a plurality of translations for a particular word, many of which, most of which, or none of which fit the context of the (foreign) text at hand. Even if one of the translations is generally appropriate, the reader is obligated to read through a plurality of translations, and to analyze—or guess—the one that suits or best suits the context. In any event, the flow of the reading is disadvantageously interrupted, and the meaning of the text may be obscured or distorted, offsetting the natural advantages inherent in reading-based methods of learning a foreign language.

The linguistic, psycholinguistic and technological bases of the inventive language-learning methods and systems may be more apparent when viewed against the general historical background of language teaching methods. The history of classroom and individual language teaching and language learning, which spans more than a century, has generally paralleled research and applications in psychology and education. The prevalent methods focus primarily on spoken language development, on interactive classroom-based learning and on beginning learners. A representative list is provided in Table 1. Virtually all of these methods sanction the use of the learner's native language, claiming that its use will prevent acquisition of a native-like accent and thinking in the target language. Only the Grammar-Translation approach, which emphasized memorization of vocabulary lists and grammatical paradigms and translation of classical texts, substantially differed from these approaches. But Grammar-Translation, prevalent in the late 18^{th} and early 19^{th} centuries, fell out of favor with the educators due to its emphasis on rote learning and reliance on translation pedagogy, and due to the rise of cognitive psychology.

TABLE 1
Language Teaching Approaches

Grammar-Translation (Johnson & Johnson 1999; Richards & Rodgers 2002)
Direct Method/Berlitz (Brown 1994; Krause 1916)
Audio-lingual Approach (Agard et al. 1944)
Natural Approach (Krashen & Terrell 1983)
Silent Way (Gattegno 1972)
Suggestopedia (Lozanov 1978)
Total Physical Response/TPR (Asher 1966, 1969)
Teaching Proficiency through Reading and Storytelling/TPRS
(Ray & Seeley 2004)
Communicative Language Teaching (Nunan 1991)
Partial or Total Immersion (Lambert & Tucker 1972)
Task-Based Language Teaching (TBLT) (Ellis 2003; Long & Robinson
1998)

The learning method and system of the present invention differs radically from previous approaches in its tripartite innovative approach, focused on:
individualized, adaptive learning
reading as the primary skill
intermediate and advanced learners.

Moreover, the inventive learning method and system does not deny the learner use of his most valued resource, his native language knowledge and skills. Rather, the invention advantageously utilizes this knowledge as an entry point to the meaning of a text, allowing the learner to focus on content, consigning grammatical form and structure appropriately to a secondary role in the learning process.

By sharp contrast, even the most recent of these approaches, Task-based Language Teaching (TBLT), places a strong emphasis on linguistic form (as opposed to content) in the development of language.

The psycho-educational theories, on which the language teaching methods are based, began with Skinnerian behaviorism in the 1940s and 1950s but moved to cognitive and information-processing approaches from the latter part of the 1960s to the present. Both theoretical orientations are relevant to second and foreign language learning and teaching, but these do not find equal expression in all aspects and at all levels of learning. For example, acquisition of vocabulary (especially concrete nouns) involves behaviorist principles such as paired-associate learning, while higher level comprehension of abstract texts involves situated-based learning which is meaning dependent and relies on more complex cognitive processes such as temporality, causality, prediction and inferencing.

Research on second language learning and teaching has largely followed theoretical work in linguistics and psycholinguistics. Studies of interference and contrastive analysis have taken on a minor role in the field, giving way to a series of cognitively-based hypotheses, which unfortunately have not been integrated with the most natural and salient feature of second language learning—first language knowledge and processing. The present invention meets this challenge by providing a full-text translation approach (i.e., in which the familiar language text is a full translation of the foreign text, and not just a local translation of a word or phrase) that is grounded in basic learning principles and supported by the most up-to-date technologies. These learning principles involve distributive and adaptive learning, based on frequency-based models of written language and processes of inhibition and activation grounded in the latest data from neuro-imaging research.

We have further found machine translations to be fundamentally unsuitable for translating the text of the foreign language into the familiar language, for use in accordance with the inventive learning method and system of the present invention. Although appreciable advances in machine translation have occurred in recent years, such translation may be suitable, at best, for enabling a basic understanding of the subject matter written in the foreign language. The translated text may be incomplete, garbled, and/or non-contextual, compromising or significantly sacrificing the reading comprehension of the reader.

In addition, the translated text may characteristically suffer from a style that has been disadvantageously changed from that of the original, foreign text. The inventive learning method and system is largely based on reader motivation, i.e., that the reading of the foreign language text—along with reading of the familiar language text, as necessary—be exciting, entertaining, or otherwise stimulating, or at the very least, free or largely free of cumbersome, frustrating and/or disconcerting phenomena associated with the translated text or access thereto. The inadequacies of machine translated text may be further apparent from the exemplary texts and machine translations thereof, provided hereinbelow. In a first example, a text from Mark Twain's Adventures of Huckleberry Finn is machine-translated into Hebrew, and then machine-translated back to English. In a second example, the text from the Adventures of Huckleberry Finn is machine-translated into French, and then machine-translated back to English. In a third example, a description of a chemical process is machine-translated into Hebrew, and then machine-translated back to English. In a fourth example, a Hebrew description of a chemical process is machine-translated into English.

### EXAMPLE 1

ORIGINAL TEXT
It was an awful sight of money when it was piled up. Well, Judge
Thatcher he took it and put it out at interest, and it fetched us a dollar a
day apiece all the year round - more than a body could tell what to do
with. The Widow Douglas she took me for her son, and allowed she
would sivilize me; but it was rough living in the house all the time,
considering how dismal regular and decent the widow was in all her
ways; and so when I couldn′t stand it no longer I lit out. I got into my old
rags and my sugar-hogshead again, and was free and satisfied. But Tom
Sawyer he hunted me up and said he was going to start a band of robbers,
and I might join if I would go back to the widow and be respectable.

MACHINE TRANSLATION INTO HEBREW

[symbol]

[symbol]

[symbol]

[symbol]

[symbol]

[symbol]

[symbol]

[symbol]

[symbol]

[symbol]

MACHINE TRANSLATION BACK INTO ENGLISH
It was a terrible sight of money when he piled up. Well, it took Judge
Thatcher is the one place it at interest, and it brought us dollars a day per
unit each year - more than a body knew what to do with. Widow Douglas
she took me for her son, and it may be sivilize me, but it was a hard life
at home all the time, given the dismal regular and decent widow was in
all ways, so when I can not stand it no longer I lit out. I went into my old
rags, my sugar hogshead again, and was content free. But Tom Sawyer
he hunted me up and said he was going to form a band of robbers, and I
can join if I will return to the widow and be respectable.

### EXAMPLE 2

MACHINE TRANSLATION INTO FRENCH
C′était un spectacle terrible de l′argent quand il s′est entassé. Eh bien, le
juge Thatcher, il le prit et le mettre [symbol] intérêt, et j′allai le chercher nous
un dollar par jour chacun toute l′année - plus d′un organe pourrait dire quoi
faire avec. La veuve Douglas, elle m′a pris pour son fits, et elle me
permet sivilize, mais il était vivant dans la rue dans la maison tout le
temps, compte tenu de la façon lamentable régulier et décent de la veuve
était dans tous ses moyens, et donc quand je ne pouvais pas stand ne plus
j′ai allumé sur. Je montai dans ma vieux chiffons et mon taux de sucre-
tonneau [symbol] nouveau, et était libre et satisfait. Mais Tom Sawyer, il m′a
chassé et a dit qu′il allait commencer une bande de voleurs, et je pourrais
joindre si je voulais revenir [symbol] la veuve et être respectable.

MACHINE TRANSLATION BACK INTO ENGLISH
It was a terrible sight of money when it was piled up. Well, Judge
Thatcher he took it and put at interest, and fetched us a dollar a day each
full year - more than a body could tell what to do with. The Widow
Douglas she took me to his son, and it allows me sivilize, but he was
living on the street in the house all the time, considering how dismal
regular and decent the widow was in all ways , and so when I could not
stand no more I turned on. I got into my old rags and my sugar-barrel
again, and was free and satisfied. But Tom Sawyer he hunted me and said
he would start a band of thieves, and I might join if I wanted to return to
the widow and be respectable.

### EXAMPLE 3

ORIGINAL TEXT
In stage 2, the decomposition of glaserite is performed preferably at a
temperature of from about 15° C. to about 90° C., with the preferred
temperature range being from about 20° C. to about 50° C. Potash and
water are introduced along with the solids obtained from the glaserite
crystallization stage. The potash and water can be mixed separately and
the solution obtained can be filtered to remove insoluble matter to
produce substantially fully soluble potassium sulfate.

MACHINE TRANSLATION INTO HEBREW

[symbol]

[symbol]

[symbol]

[symbol]

[symbol]

[symbol]

### EXAMPLE 4

ORIGINAL TEXT

[symbol]

[symbol]

[symbol]

[symbol]

[symbol]

[symbol]

[symbol]

MACHINE TRANSLATION INTO ENGLISH
Step 2, dissolution in excess Ahgilzrit performed at a temperature of
15 degrees, about 90 degrees, roughly, Achsahathum preferred is from
20 degrees, about 50 degrees or so. Potash and water are put together
with the solids obtained Ahgilzrit formulation stage. You can mix the
potash and water separately, the resulting solution can pass filter to
remove non-material - soluble, for completely soluble potassium
sulphide, in fact.

Problems with machine translations occur in many domains of linguistics, as illustrated in the difficulties drawn from Example 1 hereinabove:
Lexical ambiguity (‘awful’, ‘considering how . . . ’)
Particle verbs (piled up, got into my old rags, hunted me up)
Discourse markers (Well)
Literal translation of idioms (‘took me for’, ‘lit out’, ‘sugar-hogshead’)
Non-conventional orthography (‘sivilize’)
Tense/modality (‘couldn't stand it’ rendered in the present; ‘would go back’ rendered in future)
Person errors (‘I . . . was free’ rendered in third person)
Article errors (‘robbers’ translated with definite article)
Register errors (‘band of robbers’ rendered inappropriately as ‘flock’)

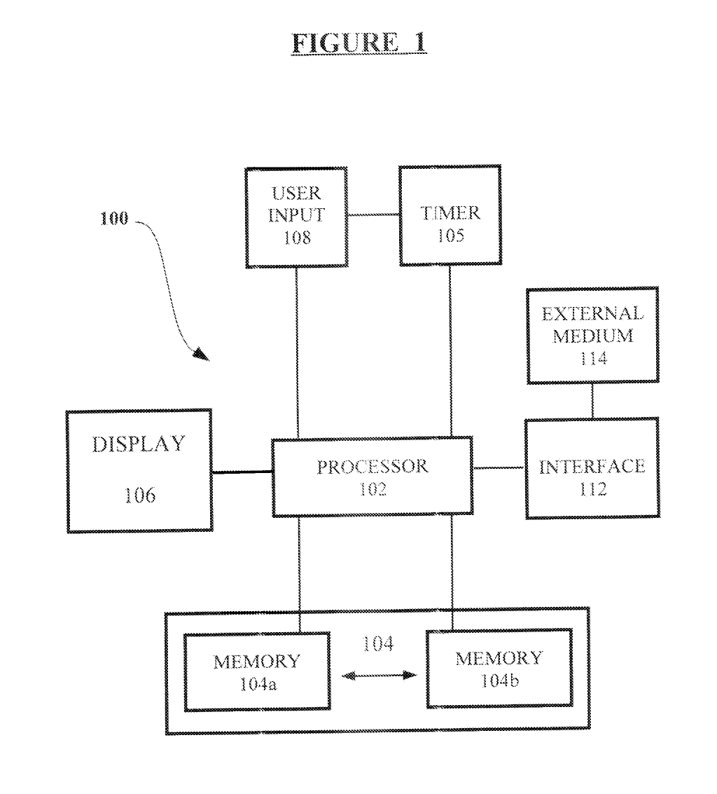

Referring now to the drawings, FIG. 1 is a block diagram of a system 100 according to one aspect of the present invention. System 100 includes a processor 102, and may include at least one memory 104 including a first memory 104a and a second memory 104b, a screen or display 106, and an input or inputting device such as user input 108. User input 108 may include a mouse, a touchscreen, or other user inputs that would be known to those of skill in the art. System 100 may further include a timer or timing device 105, within, or associated with, processor 102 or inputting device 108. First memory 104a may be adapted to contain a first or primary text in a first (“foreign”) language. Second memory 104b may be adapted to contain a second text in a second (“familiar”) language, the second text constituting a translation of the first text.

In one embodiment, processor 102 may be configured to run operating system software such as Microsoft Windows, IBM AIX or Sun Microsystems Solaris. Operating system software may in turn provide an environment in which processor 102 may execute additional software modules in the form of applications, programs, or processes designed to perform specific functions. Running operating system software or software modules may include executing instructions that are stored in memory 104. A client or server application process may reside in memory 104.

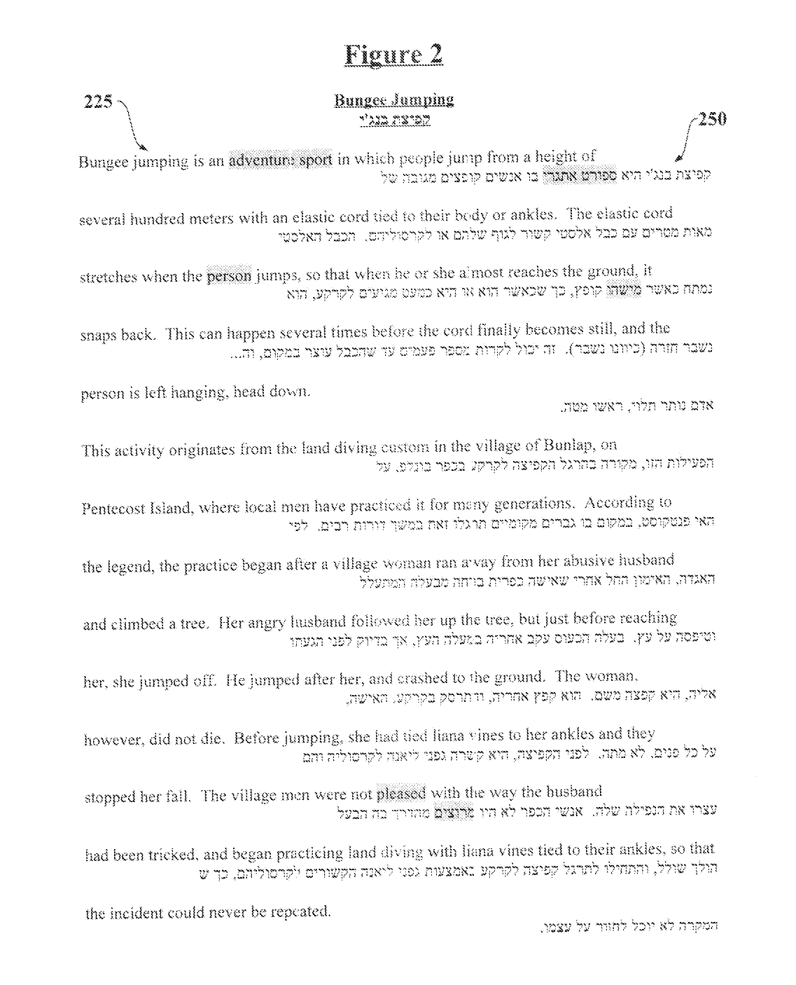

Display 106 may be adapted to display the first and second texts, or portions thereof. By way of example, FIG. 2 shows a display of an English text as a first language 225, and a Hebrew text as a second language 250, the Hebrew text constituting a translation of the English text. It may be advantageous for the translated text to be a linear translation of the primary text, whereby each translated line of text completely matches, or substantially matches, the respective line of primary text. It may be of further advantage for the two texts to be interleaved, whereby each translated line of text is juxtaposed above or below the respective line of primary text, substantially as shown in FIG. 2.

Referring back to FIG. 1, system 100 preferably includes a pairing or associating mechanism adapted to pair or associate a word, group of words, or phrase from the first text with a word, group of words, or phrase from the second text. The associating mechanism may be adapted to dispose each translated word or phrase of the translated words or phrases and a respective word or phrase of the words or phrases of the first text, within the memory, in a paired, associative structure.

The pairing or associating mechanism may utilize a pointer-based architecture wherein, by way of example, a pointer associated with a word, group of words, or phrase from one of the texts, points to or identifies a storage area, within memory 104, containing a translated word, group of words, or phrase from the corresponding, translated text. The pairing or associating mechanism may be realized as a hardware, software, or hybrid hardware-software arrangement, as will be appreciated by one of skill in the art.

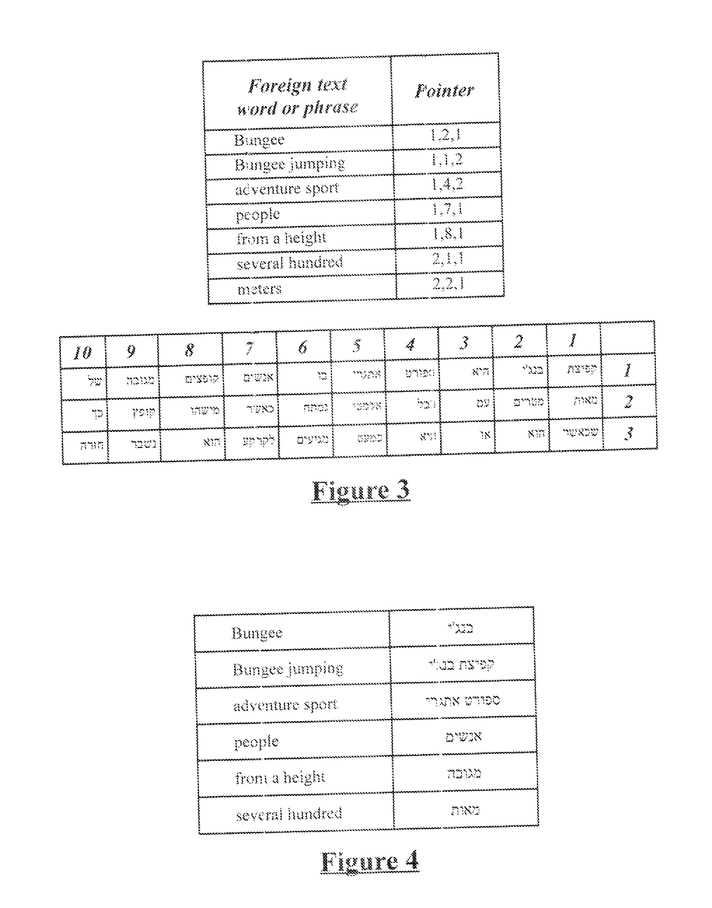

An illustrative embodiment of such a pointer-based architecture is provided in FIG. 3. Memory 104 may be adapted to store a plurality of words, group of words, or phrases from the first or “foreign” text, e.g., in a list, as shown. Associated with each word, group of words, or phrases (“keys”) from this text is associated data, stored elsewhere within memory 104. Also associated with each word, group of words, or phrases from this text is a pointer or the like, from which may be identified the location of each associated data, in this case, the respective translated word, group of words, or phrases from the second or “familiar” text. The pointer information is typically stored in a known position or location with respect to the keys.

It may be advantageous for the pointer to indicate a length of the word or phrase associated with the word or phrase from the first or foreign text.

By way of example, the pointer 1,2,1 is associated with the word “Bungee” appearing in the list of words from the first text. The left-most digit (“1”) may represent a row number or row identity of the row containing the associated data associated with “Bungee”. The second or middle digit (“2”) may represent the associated data within the identified row. The right-most digit (“1”) may represent the number of words or the number of cells containing the associated data. Thus, the pointing mechanism points to the word “ [symbol] ”, the second word (or the word within the second cell) of the first row.

Similarly, the pointer of the phrase “adventure sport” is 1, 4, 2, and indeed, the translated phrase, “ [symbol] ”, appears in the first row, beginning with the fourth word or cell, and has a length of two.

Alternatively or additionally, the pairing or associating mechanism may store, in memory 104, each word, group of words, or phrase from the second text in a one-to-one relationship with each corresponding translated word, group of words, or phrase from the first text. By way of example, and as provided in FIG. 4, memory 104 may store a table or list containing each word, group of words, or phrase from the first text (or select words and phrases), and may store each corresponding translated word, group of words, or phrase from the second text in an adjacent position or in an otherwise known relation. Such an arrangement may obviate the need for a pointing arrangement.

More generally, pairing or associating mechanism may be any of various key and associated data mechanisms, such mechanisms being known to those of ordinary skill in the art. The pairing or associating mechanism may be part of processor 102,

System 100 may further include an interface 112 adapted to enable transfer of data from an external medium or memory system 114 to processor 102, via interface 112. For example, external medium 114 may include a flash memory system storing the first text in the foreign language, and the second text in the familiar language. External medium 114 may contain the first and second texts in a pre-paired or pre-associated form. In this case, processor 102 may be adapted to access these pre-associated first and second texts via interface 112. Processor 102 may also be adapted to store these texts within system 100, typically within first memory 104a and second memory 104b.

Alternatively or additionally, processor 102 may be adapted to employ a software program having a structure enabling processor 102 to perform any or all of the above-mentioned tasks.

Alternatively, external medium 114 may contain solely the second text. Processor 102 may be adapted to (a) analyze each particular sentence of the first text (e.g., by means of linguistic principles); (b) analyze each particular, corresponding sentence of the second text (e.g., by means of linguistic principles); (c) based on (a) and (b), perform the association between corresponding words and phrases in the first text and words and phrases in the second text, for each particular sentence, and (d) storing the corresponding words and phrases in an associated arrangement within a memory such as first memory 104a and second memory 104b. Processor 102 preferably has a structure that enables processing of human translated texts, and may be incapable of, or may be designed and configured to incapable of, performing a machine translation.

External medium 114 may include Static RAMs (SRAMs), ROMs, EPROMs, E2ROMs, Flash-based, Optical, CCD, magnetic devices, and various other storage media. External medium 114 may include remote external media operatively connected to system 100 via the Internet and other communication networks known to those of ordinary skill in the art.

FIG. 5 provides a schematic illustration of a system such as a computer or computing system, a portable or laptop computer, or an electronic book reader (“e-book reader”) 500, according to one embodiment of the present invention. System 500 may include a housing 502, a display, display medium, or screen 504, a speaker 511, an I/O port 524 and input devices such as directional arrows 520, or a keyboard and/or stylus (not shown). Display or screen 504 may be a touchpad screen or the like, whereby screen 504 may also serve as an input mechanism. Screen 504 may display first and second texts 225, 250, and may further display a menu 503. The user may utilize a scroll bar 515 to move through menu 503. Different lines or pages of the original text and the translated text may be displayed on screen 504. I/O port 524 may be used for transmission of information to and from the Internet or other such communication networks. I/O port 524 may be a USB (universal serial bus) port, an infrared port, a modem, a wireless connection, an electrical port, an optical port, or any data transmission port made available or known to those skilled in the art. I/O port 524 may be used for transmission of electronic copies of original text, translated text, or other information to and/or from computer 500 and the Internet. Generally speaking, system 500 may include an Internet side memory and/or processor.

With reference now to FIG. 1 as well, inputting device 108 may advantageously be adapted to introduce or to provide a prompt to processor 102. The prompt may be a user-initiated prompt, for example, selecting (using a mouse, touchpad, touchscreen, or other devices known in the art) a word, group of words or phrase from the foreign text appearing on display 106. Processor 102 may be adapted to receive this prompt, and responsive to the prompt, to control display 106 so as to modify the appearance of the respective translated word or phrase, whereby this appearance is physically distinguished from at least a portion of the second text.

In one embodiment of the present invention, a system such as system 500 may be adapted to display a linear translation of first text 225, whereby each translated line 251 of second text 250 completely matches, or substantially matches, a respective line 226 of first text 225. It may be of further advantage for texts 225, 250 to be interleaved, whereby each translated line 251 within second text 250 is juxtaposed above or below respective line 226 of first text 225, substantially as shown in FIG. 5.

In response to a prompt using a particular word or phrase 562 of first text 225, in this case, “adventure sport”, processor 102 may locate/identify, and/or access, the associated, translated word or phrase 564, in this case, “ [symbol] ”, disposed in memory 104. Processor 102 further acts (e.g., by activating display 106), whereby a display of the translated word or phrase is physically distinguished from at least a portion of second text 250. In FIG. 5, the physical distinction is achieved by highlighting the associated, translated word or phrase 564. It will be appreciated, however, that the physical distinction may be achieved in other ways known to those of ordinary skill in the art, including, but not limited to, physical distinction by means of boldface, italics, font size, font color, underlining, and flashing.

It may be advantageous for particular word or phrase 562 of first text 225 (in this case, “adventure sport”) to be physically distinguished from other words or phrases of first text 225. The physical distinction may be similar or identical to that of associated, translated word or phrase 564, to emphasize, to the reader/user, the connection between the translated term and the original term.

It will be appreciated that there exist various embodiments of the present invention, including:
a local, handheld or laptop or desktop computer allows for storage of a software program as well as data. The storage and data may reside on a hard disk, memory, flash drive or any other data storage mechanism. By way of example, this local computer may download the program via a network (e.g., via the Internet from a central server), to be run locally. This program may be adapted to download original-language text and secondary-language text. The program may be further adapted to download pointers or other means known in the art for associating/pairing the various text segments (e.g., paired words or paired phrases) of the original-language text and the translated secondary-language text. Such text-correlation may include multiple-level association, for translation of whole paragraphs, sentences, phrases and individual words. In addition, the text-correlation segment may be associated with a pre-recorded audio or video.
the software program is located and run on a central server only. The texts and their associated pointers (or other pair identification means), as well as any audio and video files, will be downloaded to the local computer. The user may then run the remote software on the user's local data.
the software program is located and run on a local computer only. The texts and any pointers associated therewith (or other pair identification means), as well as any audio and video files, may be streamed to the local computer, and may be provided to the user solely for the duration for which the user views the particular segment of text. Upon leaving the particular text, the data may be removed from local memory.
the software program is located and run on a central server only. The texts and their associated pointers, as well as any audio and video files, may be streamed to the local computer, and may be provided to the user only for the duration for which the user views the particular segment of text. Upon leaving the particular text, the data may be removed from local memory.

System 500 may be further adapted (e.g., by means of processor 102) to remove the physical distinction after a pre-determined time (e.g., by means of timing device 105), or after the user removes the prompting unit (e.g., by movement of a cursor) or contacts the touchpad or touchscreen in a particular manner. The physical distinction may also be removed when the user prompts system 500 to indicate another word or phrase 562 of first text 225, or to perform another operation.

Alternatively or additionally, system 500 may have a mode in which first text 225 is “read” at a pre-determined pace. In other words, system 500 acts upon display 504, whereby is displayed a first physically distinguished word or phrase of first text 225, along with the associated, translated word or phrase of second text 250. After a particular or pre-determined time (e.g., utilizing timing device 105), a succeeding word or phrase of first text 225 appears in a physically distinguished manner, along with the associated, translated word or phrase of second text 250. After another particular or pre-determined time, another succeeding word or phrase of first text 225 appears in a physically distinguished manner, along with the associated, translated word or phrase of second text 250.

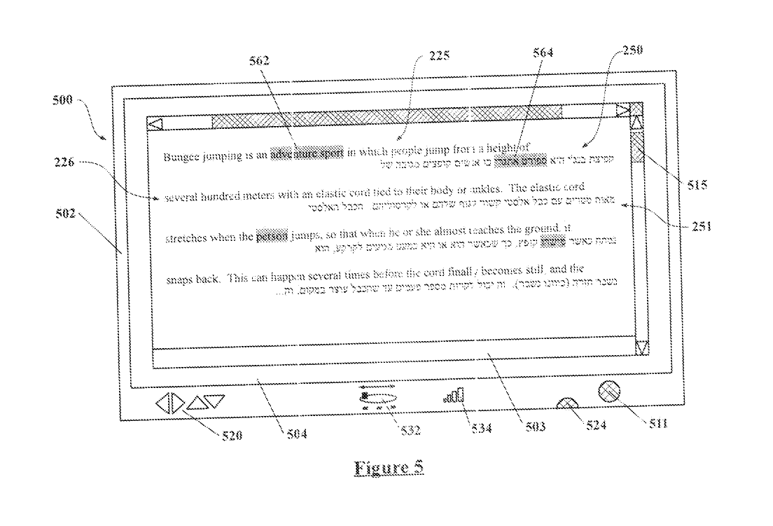

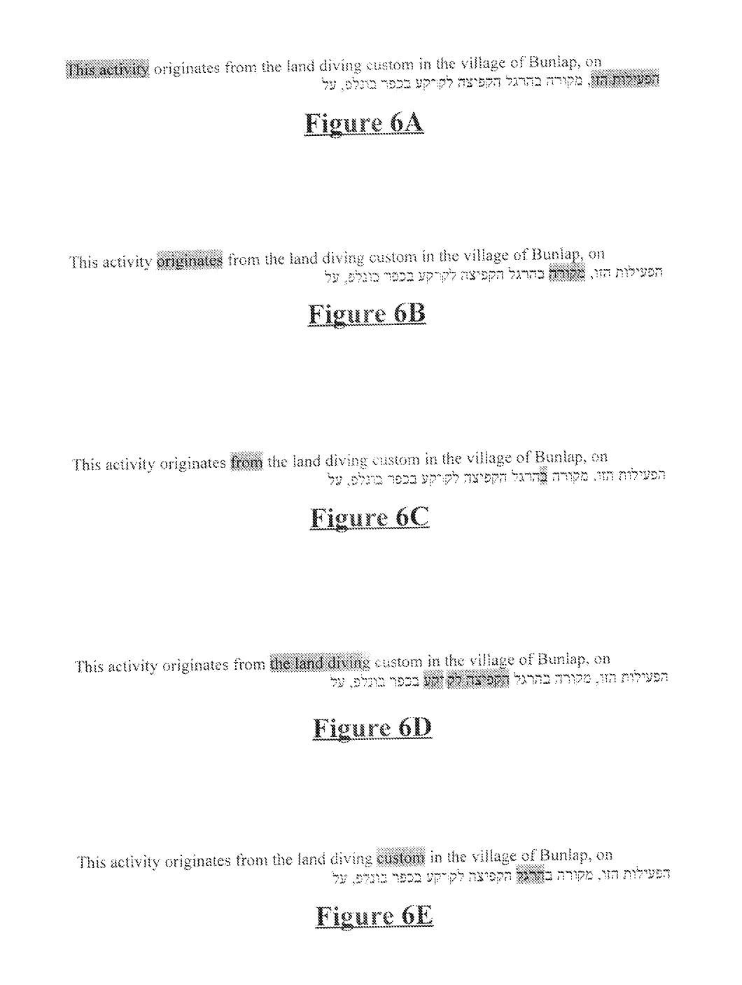

This mode of operation is shown in exemplary fashion in FIGS. 6A-6E.

System 500 may further include a mode switch or changer 532, adapted to enable the user to select between the various modes of operation. The pre-determined pace mode of system 500 may be a variable pre-determined pace mode, in which a control or pace input control 534 may be adapted to enable the user to select or set a desired pace for the advancement of the physically distinguished words or phrases in the first text and in the corresponding set of translated words or phrases of the second text.

In another aspect of the present invention, system 500 may include an audio mode in which a first text such as first text 225 may be provided, alternatively or additionally, in audio form.

First text 225 may be read aloud at a particular or pre-determined pace, such that a succession of words and/or phrases of first text may be audibly provided to the user of system 500, by an audio mechanism, e.g., a mechanism including speaker 511. Processor 102 may act to display, preferably in a physically distinguished manner, those particular words or phrase (e.g., word or phrase 562) of first text 225, substantially concurrently with, or in overlapping fashion to, their delivery by the audio mechanism.

As described hereinabove, processor 102 may locate, and/or access, the translated word or phrase (e.g., word or phrase 564), associated with the particular word or phrase of first text 225, and may further act (e.g., by activating display 106), whereby a display of each translated word or phrase is physically distinguished from at least a portion of second text 250. Examples of this operation have been provided in FIGS. 5 and 6A-6E, and have been described in greater detail hereinabove.

Also as described hereinabove, the physical distinction of a particular word or phrase of first text 225 may be similar or identical to the physical distinction of associated, translated word or phrase 564, to emphasize the connection between the term provided out loud, and the original term.

Mode switch or changer 532 may be further adapted to enable the user to select at least one mode of operation including an audio mode.

The method and system of the present invention may be utilized as a diagnostic tool for determining foreign-language level and/or weak points for strengthening. For example, after determining the foreign-language level of the reader, the diagnostic tool/system may recommend a particular level for the next text to be read by the reader.

The method and system of the present invention may be adapted to test the reader, based on his particular performance, or to provide a review for the reader based on his particular performance after the reader has completed reading the text. For example, the method and system of the present invention may be adapted to utilize the reader-initiated prompts as part of the review/test to examine the reader's acumen and/or to reinforce the reader's newly acquired knowledge.

As used herein in the specification and in the claims section that follows, the term “line”, with respect to a text (e.g., a line of the second text) typically has at least 20 characters, more typically, at least 30 characters, and yet more typically, at least 40 or at least 50 characters. Typically, a line includes a plurality of words and/or a plurality of phrases. The word count of a typical line is at least 4 words, at least 5 words, at least 6 words, or at least 8 words. It will be appreciated that in certain languages, including but not limited to Chinese and Japanese, a single character may represent a word or phrase. In such languages, the word count defined above is defined as a character count.

As used herein in the specification and in the claims section that follows, the general term “prompt” is specifically meant to include both a user-activated prompt and a prompt initiated by a timing mechanism, device or arrangement.

As used in the claims section that follows, the term “phrase” is meant to include a group of words.

As used in the claims section that follows, the term “associating mechanism” is meant to include hardware, software, and hybrid hardware-software arrangements.

As used in the claims section that follows, the term “processor is adapted” and the like is meant to include hardware arrangements, software-enabled hardware arrangements, and hybrid hardware and software-enabled hardware arrangements.

As used herein in the specification and in the claims section that follows, the term “human translation” is specifically meant to exclude machine translations. However, the term “human translation” is specifically meant to include machine translations that have subsequently been edited or amended by a human being. The term “solely human translation” and the like is specifically meant to exclude machine translations that have subsequently been edited or amended by a human being.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference.

What is claimed is:

1. A computer-implemented language learning system for facilitating learning of a foreign language by a human reader having relative fluency in a familiar language, the system comprising:
(a) a processor;
(b) a memory, associated with said processor, said memory adapted to store:
(i) a first text in a first language, said text including a first plurality of words or phrases, said plurality having a length of least 50 words, and
(ii) a pre-translated second text in a second language, said pre-translated second text including a human, contextual, translation of said first text, said second text including a second plurality of translated words or phrases, said second plurality having a length of least 50 words,
said processor and said memory including an associating mechanism adapted to dispose each translated word or phrase of said translated words or phrases and a respective word or phrase of said words or phrases of said first text, within said memory, in a paired, associative structure;
(c) a display medium, responsive to said processor, said medium adapted to simultaneously display:
(i) a plurality of lines of said first text, wherein each line of at least two lines of said plurality of lines of said first text includes at least two phrases of said first plurality of said phrases, and
(ii) a plurality of translated lines within said pre-translated second text, said translated lines including translated lines corresponding to said two lines of said first text, wherein each translated line of at least two translated lines of said plurality of translated lines includes at least two phrases of said second plurality of said phrases,
said processor being adapted, after each said translated word or phrase of said translated words or phrases and said respective word or phrase of said words or phrases of said first text are disposed within said memory in said uniquely associated or paired manner,
(i) to receive a prompt pertaining to a first word or phrase on a particular line of said two lines of said first text, and responsive to said prompt, and
(ii) to identify, using said paired structure, a particular translated word or phrase of said plurality of translated words or phrases in said pre-translated second text, said particular translated word or phrase being a human, contextual translation of said first word or phrase; and
(iii) to control said display medium, to modify an appearance of said particular translated word or phrase, whereby a display of said particular translated word or phrase is imparted with a physical distinction with respect to at least a portion of a corresponding translated line within said at least two translated lines.

2. The system of claim 1, a timing device being adapted to provide, to said processor, a series of prompts, including said prompt, each of said prompts pertaining to a different word or phrase of said first text, wherein said processor is adapted, responsive to each particular prompt of said prompts, to identify an associated translated word or phrase of said plurality of translated words or phrases that is associated with said particular prompt, and to control said display medium, to modify said appearance of said associated translated word or phrase, whereby a display of said associated translated word or phrase is imparted with a physical distinction with respect to other words on a same line within said second text.

3. The system of claim 1, said processor being further adapted to control said display medium, in response to said prompt, to modify an appearance of said first word or phrase of said first text, whereby a display of said first word or phrase is imparted with a physical distinction with respect to at least a portion of said particular line of said first text.

4. The system of claim 3, said appearance of said first word or phrase being substantially identical to said appearance of said particular translated word or phrase.

5. The system of claim 1, said processor and said display adapted such that said first text and said second text are arranged in at least one of the following ways:
(i) said first text and said second text are interleaved;
(ii) each said line of said second text is juxtaposed above or below each said line of said first text; and
(iii) each said line of said second text is substantially a linear translation of each said line of said first text.

6. The system of claim 1, the system adapted, in assembled form, such that at least one of said processor and said memory is disposed on a remote side of the system, and said display medium is on a local side of the system, said remote side and said local side adapted to communicate via a communication network.

7. The system of claim 2, said timing device being adapted to provide said series of prompts at a particular time interval, said interval being adjustable by a user of the system, via an input device adapted to define said time interval.

8. The system of claim 7, further comprising a pace input device, associated with at least one of said timing device and said processor, said pace input device adapted to enable said user to set a particular pace for said series of prompts.

9. The system of claim 7, further comprising a mode switch, associated with at least one of said timing device and said processor, said mode switch adapted to enable said user to select between a plurality of modes of operation, said modes including a variable pace mode providing said series of prompts at said particular time interval, and a user-activated input mode in which said user effects said prompts by means of a user-activated input device.

10. The system of claim 1, further comprising:
an audio arrangement adapted to deliver said first text as audible text, and
a mode switch, associated with at least one of said timing device and said processor, said mode switch adapted to enable said user to select between a plurality of modes of operation, said modes including a pace mode providing said series of prompts at said particular time interval, and an audio mode in which said audio arrangement effects a delivery of said first text as said audible text.

11. The system of claim 10, said processor being further adapted to control said display medium, in response to said prompt, to modify an appearance of said first word or phrase of said first text, whereby a display of said first word or phrase is imparted with a physical distinction with respect to at least a portion of said particular line of said first text,
and said display of said first word or phrase being imparted with said physical distinction substantially concurrently with, or in overlapping fashion to, said delivery of said first word or phrase of said first text as said audible text.

12. The system of claim 1, said length of said first plurality of words or phrases, exceeding 100 words, and said length of said second plurality exceeding 100 words.

13. The system of claim 1, at least said two lines of said first text and at least said two lines of said second text having at least 5 words.

14. The system of claim 1, said processor being adapted to store a record of user-initiated prompts, and to provide, via said display medium or other output medium, a review of words or phrases associated with said user-initiated prompts, whereby a language learning of the reader is reinforced.

15. The system of claim 1, said processor being adapted to store diagnostic information on a reading performance of the reader, said diagnostic information including a record of user-initiated prompts.

16. The system of claim 15, said processor being further adapted to evaluate, based on said diagnostic information, a foreign-language level of the reader.

17. The system of claim 15, said processor being further adapted to evaluate, based on said diagnostic information, weak points of the reader that require strengthening.

18. The system of claim 1, said processor being adapted to store a record of user-initiated prompts, and based on said record, to provide, via said display medium or other output medium, a test of a language learning of the reader.

19. The system of claim 15, said first text being a plurality of first texts, said second text being a plurality of translated second texts, and said processor being further adapted to recommend, based on said diagnostic information pertaining to the user, a user-appropriate level of said first texts.

20. The system of claim 1, said pre-translated second text and said first text being pre-associated.
